(19) United States
(12) Patent Application Publication
(10) Pub. No.: US 2020/0037643 A1
(43) Pub. Date: Feb. 6, 2020

(54) DRIED PASTA BASED ON LEGUMES AND PROCESS FOR THE PRODUCTION THEREOF

(71) Applicant: BARILLA G. E R. FRATELLI S.P.A., Parma (IT)

(72) Inventors: Manuel MARIANI, San Lazzaro di Savena (Bologna) (IT); Sonia BOCCHI, Sorbolo (Parma) (IT); Alessandro D'ALESSANDRO, Parma (IT)

(21) Appl. No.: 16/488,740

(22) PCT Filed: Mar. 8, 2018
(86) PCT No.: PCT/EP2018/055703

§ 371 Date: Aug. 26, 2019

(30) Foreign Application Priority Data
Mar. 17, 2017 (IT) 102017000029934

(51) Int. Cl. A23L 7/109; A23L 11/00; A21D 13/045; A21D 13/066

(52) U.S. Cl. CPC A23L 7/109; A23L 11/05; A23V 2002/00; A21D 13/066; A21D 13/045

(57) ABSTRACT

A dried pasta based on a meal comprising a pre-cooked flour of peeled legumes in an amount of at least 50% by weight of the total weight of the meal, wherein said dried pasta is free of binding agents and said legume flour has a protein dispersability index (PDI) greater than or equal to 55.

### FIELD OF APPLICATION

The present invention relates, in general, to the sector of the food industry. In particular, the invention relates to a dried pasta comprising a flour of legumes and to the process for the production thereof.

### PRIOR ART

In Italy, “durum wheat semolina pasta” and “durum wheat semolato pasta” are the products obtained from the extrusion or rolling and subsequent drying of doughs prepared respectively and exclusively using durum wheat semolina and ‘semolato’ and water (Law 580/67).

The conventional methods of the prior art for preparing a dried pasta usually comprise the operations of:

a) mixing, wherein the durum wheat semolina or ‘semolato’ is mixed with 20-30% water, with the consequent formation of gluten and hydration of the starch, so as to form a dough;

b) kneading, wherein the dough is worked until an optimum consistency and plasticity is obtained;

c) extrusion, wherein the dough is pushed through pipes with a particular cross-section so as to assume the desired shape and size;

d) drying, when the dough leaves the extrusion dies, so as to bring the moisture of the dried pasta to 12.5%; the drying step also involves exposure of the pasta to a high temperature, also of up to 105° C. for two or three hours;

e) cooling at room temperature and subsequent packaging.

The operations a) to c) of mixing, kneading and extrusion are commonly carried out together using an extruder.

Although, as mentioned above, traditional dried pasta involves the exclusive use of durum wheat semolina, it is known, in the sector for the production of dried pasta, to combine durum wheat semolina meal with flours based, for example, on legumes in order to modify the nutritional profile of the said meal and the dried pasta obtained from it.

In the present application the term “pasta” will be used to refer to a product which is entirely similar to “durum wheat semolina pasta”, as defined in the aforementioned law, as regards moisture content, consistency and cooking times, even though it does not comply with the requirements of the law in question which envisages the use of this name only for products containing at least 50% of durum wheat semolina.

The legumes which are most commonly used are lentils of varying colors (in particular red lentils), chickpeas, green peas, beans and soybean and, generally, only one type of legume is used for production of the pasta.

Vegan, gluten-free, biological, low in carbohydrates, but rich in vegetable proteins and fibres, legume-based pasta is one of the latest trends in the food and catering sector, suitable for vegan consumers or persons suffering from gluten-intolerance or diabetes and ideal for persons who like to keep fit or follow a healthier lifestyle.

Some products which are commercially available (for example “Sedanini 100% bio red lentils—gluten-free” and “Fusilli 100% bio green peas—gluten-free” sold by “Felicia Bio”) consist of a pasta composed exclusively of flour of legumes (red lentils and green peas, respectively) obtained by means of a flour gelatinization process which takes place during the pasta production step, by means of the addition of significant percentages of water vapour to the dough inside the extruder.

Also commercially available is semolina pasta obtained from a dough comprising durum wheat semolina and a flour of legumes, in particular chickpeas; this pasta, however, does not maintain the desired consistency during cooking, becoming sticky and having an unpleasant taste.

The international patent application WO 2015/158960 describes a method for the production of a gluten-free pasta obtained by grinding fava beans and fractioning the flour thus obtained, selecting the coarsest fraction (mixed subsequently with water to obtain the final dough). The purpose of fractioning is to remove the anti-nutritional compounds contained in the smallest fractions from the fraction used for preparation of the dough. The dough may also comprise flour of gluten-free cereals, tubers or other types of legumes and an emulsifier such as egg, lecithin, mono- and diglycerides of fatty acids or derivatives thereof.

The U.S. Pat. No. 5,087,470 describes a pasta obtained using flour of black mung bean (also known by the name of “urad”) to which flours obtained from cereals other than wheat are added. Pasta containing 100% urad flour has a cooking time of 1-2 minutes, compared to the 5-10 minutes required for durum wheat pasta.

International patent application WO 1997029648 describes pasta produced by means of cold extrusion from a coarse flour with a low gluten content or with no gluten, which may be obtained from wheat, legumes, tubers or green vegetables, in combination with water and a mixture of guar gum and xanthan gum used as stabilizers.

The patent application US 2002/0155206 A1 relates to a high-protein pasta comprising soybean flour in an amount greater than 50% by weight, durum wheat flour (preferably semolina), gluten and egg or egg white, which are used as binding agents.

The aforementioned documents of the prior art teach that, in order to be able to incorporate large concentrations of legume flour in meal intended for the production of dried pasta, it is necessary to adopt a number of measures, such as using binding agents or alternative or additional methods for production of the dried pasta, such as gelatinization and/or pre-gelatinization of the starch.

However, the presence of functional binding ingredients is not always desirable, in particular in those cases where the aim is to provide a dried pasta which is regarded by the consumer as being a simple and genuine product. In addition, there are cost-related considerations since the use of functional binding ingredients could influence the production cost of the finished product.

The problem underlying the present invention has therefore been that of providing a dried pasta based on a meal comprising legume flour, which has optimum organoleptic properties, in particular a consistency similar to that of conventional dried pasta prepared from a meal of durum wheat semolina, and is able to be produced by a conventional method for production of a dried pasta based on only durum wheat semolina, without having to add stabilizing or binding agents.

### SUMMARY OF THE INVENTION

Such a problem has been solved by a dried pasta based on a meal comprising a pre-cooked flour of peeled legumes in an amount of at least 50% by weight of the total weight of said meal, wherein said dried pasta is free of binding agents and said legume flour has a protein dispersibility index (PDI) greater than or equal to 55.

Preferably, the pre-cooked legume flour has a protein dispersibility index (PDI) greater than or equal to 60, preferably of between 70 and 80.

Preferably, the pre-cooked legume flour is a flour of one or more legumes selected from the group consisting of green peas, fava beans, lentils, chickpeas and mixtures thereof and is preferably a flour of lentils and/or chickpeas.

In one embodiment, the meal consists of a pre-cooked flour of dehusked lentils having a PDI of between 70 and 80, preferably equal to 76.

In another embodiment, the meal consists of a pre-cooked flour of peeled chickpeas having a PDI of between 55 and 60.

In a further embodiment, the meal consists of a mixture of pre-cooked flours of legumes, comprising:
a pre-cooked flour of dehusked red lentils having a PDI of between 70 and 80, in an amount comprised between 30% and 60%, by weight of the total weight of the meal.
a pre-cooked flour of peeled fava beans having a PDI of between 60 and 70, in an amount comprised between 30% and 60%, by weight of the total weight of the meal,
a pre-cooked flour of peeled green peas having a PDI of between 60 and 70, in an amount comprised between 2% and 15%, by weight of the total weight of the meal,
a pre-cooked flour of dehusked yellow lentils having a PDI of between 55 and 65, in an amount comprised between 2% and 15%, by weight of the total weight of the meal,
a pre-cooked flour of peeled chickpeas having a PDI of between 55 and 65, in an amount comprised between 2% and 20%, by weight of the total weight of the meal.

Preferably, the meal consists of a mixture in a weight ratio 1:1 of precooked flour of dehusked red lentils having a PDI of between 70 and 80 and pre-cooked flour of peeled fava beans having a PDI of between 60 and 70.

In one embodiment, the meal consists of the pre-cooked flour of peeled legumes and a gluten-containing cereal flour or semolina.

Preferably, the meal comprises 50% to 80% by weight of said pre-cooked flour of peeled legumes.

Preferably, the gluten-containing cereal flour or semolina is durum wheat semolina.

Preferably, the pre-cooked flour of peeled legumes consists of at least one of the legume flours as defined above.

In another embodiment, the present invention relates to a dried pasta free of binding agents based on a meal comprising a pre-cooked flour of peeled legumes in an amount of at least 50% by weight of the total weight of said meal, wherein the legume flour has a protein dispersibility index (PDI) greater than or equal to 55 and wherein the meal consists of the aforementioned pre-cooked flour of peeled legumes and a pre-gelatinized flour of at least one gluten-free cereal.

The latter is preferably selected from the group consisting of corn, rice, buckwheat and quinoa.

The present invention relates furthermore to a process for the production of a dried pasta as defined above, comprising the steps of:

a) mixing, wherein said meal comprising a pre-cooked flour of peeled legumes with a protein dispersibility index (PDI) greater than or equal to 55 in an amount of at least 50% by weight of its total weight is mixed with a quantity of water equal to 35-40% by weight of said meal to obtain a dough;

b) kneading;

c) extruding, and

d) drying, in order to bring the moisture content of the dry pasta to a value lower than or equal to 12.5%.

Preferably, the mixing step a) occurs at room temperature (20-50° C.) for 20-30 minutes.

Advantageously, the legume flour used according to the present invention is derived from legumes which are peeled (or dehusked depending on the type of legume); the use of the internal part of the legume not only ensures that the pasta product according to the invention has optimum structural characteristics, which are maintained also during and after cooking, but also ensures that the pasta is more digestible.

Moreover, the legume flours used in the present invention advantageously have a PDI (protein dispersibility index) of at least 55, preferably a value of at least 60, and advantageously a value of between 71 and 80, so as to ensure the correct forming of the final product, a uniform consistency during and after cooking, as well as a high protein content.

Further advantages arise from the bland heat treatment which the legume flours undergo, since this treatment allows inactivation of the enzymes which produce a browning reaction during the product mixing and drying step, eliminates any anti-nutritional ingredients contained in the legumes, and ensures at the same time a partial “deflavouring” of the legumes, as a result of which the bitter taste of the legumes is masked during tasting of the finished product, preventing at the same time coagulation of the proteins. This ensures that the high value of the PDI needed to obtain the pasta according to the present invention is maintained.

Moreover, this bland heat treatment, differently from the heat treatment according to the prior art, allows the pasta to be obtained without the use of any type of binding agent, since the flours obtained following this treatment have cohesive and structural properties such as to ensure that the form and consistency of the pasta is maintained during cooking by the consumer.

A further advantage of the invention consists in the fact that the flours used to produce the pasta according to the invention may be processed during the mixing and dry extrusion steps in conditions which are entirely comparable to those used in the corresponding steps for preparation of a pasta based on durum wheat semolina.

### DETAILED DESCRIPTION OF THE INVENTION

The present invention relates to a dried pasta based on a meal comprising a pre-cooked flour of peeled legumes in an amount of at least 50% by weight of the total weight of said meal, wherein said dried pasta is free of binding agents and said legume flour has a protein dispersibility index (PDI) greater than or equal to 55.

The term “dried pasta” is understood as meaning here a pasta with a maximum moisture content of 12.5%.

The term “legumes” is understood as meaning here the edible seeds of plants belonging to the family of Leguminosae (or Fabaceae), for example beans (Phaseolus vulgaris L.), green peas (Pisum sativum L.), fava beans (Vicia faba L.), lentils (Lens culinaris L.), chickpeas (Cicer arietinum L.), soybean (Glycine max L.), lupins (Lupinus sp.) and grass peas (Lathyrus sativus).

Preferably, said flour of legumes comprises at least one legume selected from the group consisting of beans, green peas, fava beans, lentils (in particular red lentils and yellow lentils), chickpeas, soybean, lupins, grass peas and mixtures thereof, preferably red lentils, yellow lentils, fava beans, green peas and chickpeas.

According to the invention, the legumes used are peeled or dehusked depending on the type of legume (for example, lentils are dehusked, while chickpeas are peeled), namely they do not have the peel or the external cuticle of the seed, since only the internal part of the legume helps maintain the form of the finished pasta during cooking.

Moreover, the peel and the cuticle contain a number of oligosaccharides (including raffinose and stachyose) which make the legumes not easily digestible both for adults and for children; consequently, the removal of these parts of the legume makes the pasta according to the invention more digestible.

In some embodiments, the present invention envisages a pasta made exclusively using a flour of at least one legume.

In other embodiments, the present invention also relates to a pasta made using a meal consisting of pre-cooked flour of peeled legumes and gluten-containing cereal flour or semolina.

The expression “gluten-containing cereal meal” is understood as meaning here a cereal meal which, in the presence of water, is able to form gluten from the glutenins and gliadins contained in it. Glutenins and gliadins are present mainly in the endosperm of the caryopses of cereals such as wheat, spelt and kamut.

During the preparation of conventional dried pasta, namely based on only durum wheat semolina, the gliadin and glutenin proteins of the semolina present in the dough, together, form the gluten, a network visible under the microscope, which gives the dough its viscosity and elasticity, thus forming a cohesive dough.

When, however, it is attempted to incorporate a legume flour in a durum wheat semolina meal, in the prior art it has been found that the incorporation of large percentages of legume flour using a conventional dried pasta production method produces unsatisfactory results.

In fact, when using traditional methods, it is not possible to form a cohesive dough which allows the production of a dried pasta which is comparable in terms of consistency to traditional pasta.

It is believed that this is due to the different nature of the legume proteins compared to those of durum wheat semolina, with the result that the legume proteins, when present in concentrations above a certain limit value, interfere with the formation of the proteic network and therefore make it impossible to obtain a dough having a consistency suitable for extrusion based on the methods commonly used in the production of dried pasta.

In order to be able to incorporate successfully a greater concentration of legumes, it is therefore required to take measures aimed at compensating for the absence, or the reduced concentration, of gluten in the dough.

These measures generally consist in the addition of binding agents.

The expression “binding agents” is understood as meaning here additional functional ingredients which have the function of increasing the cohesion of the dough. Examples of these agents comprise, for example, egg white, starch, whey proteins, alginates or gluten.

Alternatively, it is possible to use dough processing techniques different from and/or in addition to the conventional techniques, such as pre-gelatinization and/or gelatinization of the starch.

It has now, however, been surprisingly discovered that the suitability of legumes for incorporation in a meal used for the production of dried pasta based on conventional methods is closely linked to the protein dispersibility index (PDI).

It has been noted in fact that the higher the latter the better the performance of the legumes in the production of dried pasta using conventional methods.

The expression “protein dispersibility index” (PDI) is understood as meaning here the total percentage of protein which is dispersed in water under standard conditions.

The PDI is therefore a measurement of the solubility of a protein in water and, more precisely, indicates the total percentage of protein which is dispersed in water under standard conditions. A PDI of 100 indicates a total solubility of the proteins and is the value typical of proteins in their native state, namely in the state where they have not undergone thermal, chemical or enzymatic treatment and generally are not coagulated.

It is considered that coagulation of the proteins, in addition to producing a reduced dispersibility of the proteins in water, also prevents them from interacting both with each other and with the gluten proteins provided, for example, by the durum wheat semolina.

The degree of coagulation of the proteins, and therefore their availability to form bonds and create the proteic network, is closely linked to the PDI.

For this reason, it is preferable to select a legume flour with a high PDI if it is desired to incorporate the latter in a meal for the production of a dried pasta.

However, during the incorporation of legume flours in a meal for the production of a dried pasta, the pre-cooking of the raw legumes, and therefore their exposure to heat, is considered often to be a necessary step for eliminating the most unpleasant aftertastes, deactivate some of the enzymes and adapt the cooking time of the raw legumes (which is usually much longer than that of durum wheat semolina) to the cooking time of a conventional dried pasta.

Generally, therefore, for the reasons explained above, in the prior art, the legume flours used for incorporation in a meal for the production of a dried pasta have a PDI which is considerably lower than that associated with the native state, because it is known that the heat causes coagulation of the proteins, thus diminishing their water dispersibility.

In order to overcome the aforementioned problem, therefore, according to the present invention, the legumes undergo a bland heat treatment before being ground to produce the flour; alternatively, the present invention envisages that, once the flour has been obtained from the peeled legume, the flour is subjected to a bland heat treatment.

The expression “bland heat treatment” is understood as meaning here a heat treatment to which the legumes are subjected as such, namely before obtaining the corresponding flours, or, alternatively, the legume flours, characterized in that it may be carried out at not excessively high temperatures for a short period of time.

This bland heat treatment may be carried out on legumes or on legume flours while they are passing inside ducts crossed by a parallel or counterflow of steam or inside an autoclave.

In particular, the temperature applied during treatment inside an autoclave ranges between 100° C. and 110° C. for 2-15 minutes; while the temperature of the treatment performed inside the ducts is lower than the temperature in the autoclave, namely ranges between 60° C. and 80° C., and the heat treatment is applied for a longer period of time, namely for up to 30 minutes.

This bland heat treatment surprisingly gives rise to many advantages.

It is in fact sufficient to inactivate the enzymes which produce a browning reaction during the product mixing and drying step in order to eliminate any anti-nutritional ingredients contained in the legumes and ensure at the same time partial lessening (“deflavouring”) of the typical bitter taste of legumes, so as to render the finished product pleasing to the palate of the consumer.

At the same time, the temperature conditions and duration of this treatment are suitable for preventing or at least reducing drastically coagulation of the proteins, thus maintaining a high PDI value, typical of the legume flours to be used in the present invention.

Consequently, since the proteins in the legumes do not coagulate during this bland heat treatment and may therefore interact with each other to form the aforementioned proteic network, the use of any type of binding agent is entirely unnecessary since the flours obtained following this treatment have cohesive structural properties such as to ensure that the pasta keeps its form and consistency during and after cooking by the consumer.

Moreover, according to the present invention, legume flours with a high PDI and in any case greater than or equal to 55, are selected in order to ensure an abundant presence of proteins dispersed in water able to create the proteic network and thus avoid the addition of stabilizing agents and/or binders.

The present invention will be further described with reference to some examples of embodiment provided hereinbelow way of a non-limiting example.

### EXAMPLE 1

### Pasta Based on Pre-Cooked Flour of Red Lentils

Bland Heat Treatment of Lentils

The dehusked dried red lentils split into two are treated with steam in an autoclave (continuous autoclave) at 105° C. for 5 minutes.

After this treatment, the lentils are flaked, dried and ground, thus obtaining a pre-cooked flour of red lentils (PDI 76).

Process for the Preparation of Pasta Based on Pre-Cooked Flour of Red Lentils

12 kg of pre-cooked flour of dehusked red lentils thus prepared were placed inside a batch mixer.

Mixing was carried out under the conditions used for durum wheat semolina pasta shown in the following table:

| | |
|---|---|
| Dosage | Total |

| | | | | |
|---|---|---|---|---|
| Pre-cooked dehusked | 97 | kg/h | 224 | kg |
| lentil flour | | | | |
| Water at 37.6° C. | 48 | l/h | 96 | l |

Dosage of the added water was equal to 38% w/w and the mixing time was 25 minutes at a temperature of 33.7° C.

The cooker/extruder used during this step is the Polymatic cooker/extruder manufactured by the company Buehler.

The dough was extruded in the form of spaghetti (diameter 1.75 mm) and was then dried with a heat cycle similar to that which is used for the production of semolina pasta with high temperature (HT) cycles of between 70° C. and 80° C.

The pasta obtained cooked in about 13-15 minutes and was characterized by a consistency of 14 Joule/100 g, namely more than double the value of the semolina pasta which has a consistency of 6 Joule/100 g.

These results show how, after cooking, the structural properties and consistency of the legume pasta according to the invention are maintained in an excellent manner, being comparable to or better than the same characteristics of a durum wheat semolina pasta.

### EXAMPLE 2

### Pasta Based on Pre-Cooked Flour of Chickpeas

Bland Heat Treatment of the Chickpeas

The method according to the present invention for treating coarser legumes such as chickpeas (suitable also for beans and fava beans) involves peeling the legume, rough grinding the legume without the peel and the addition thereto of water in an amount equal to 40% of the weight of the legume, so as to form a dough, which is treated with steam at 105° C. for 30-60 seconds in a turbo-cooker such as that manufactured by the company VOMM, which is formed by a horizontal cylindrical module provided with a coaxial heat jacket, inside which a axial bladed rotor rotates, and then transferred into a fluid-bed drier (e.g. a turbo-drier manufactured by the company VOMM, also consisting of a horizontal cylindrical module provided with a coaxial heat jacket, inside which a coaxial bladed rotor rotates), being then broken down and reduced into agglomerates which are ground as required, thus obtaining a precooked flour of peeled chickpeas (PDI 56).

Process for the Preparation of Pasta Based on Pre-Cooked Flour of Peeled Chickpeas

The pre-cooked flour of peeled chickpeas is subjected to the same process according to the invention described in Example 1.

Pasta of the rigatoni type was obtained from the mixer-extruder, said pasta having a cooking time of about 9 minutes and being characterized by a consistency similar to that of pasta of similar shape and size made with durum wheat semolina.

### EXAMPLE 3

### Pasta Based on Red Lentils, Fava Beans, Green Peas, Yellow Lentils and Chickpeas

The pasta based on five legumes according to the invention contains the following legumes in the percentage proportions by weight of the total weight of the flour indicated:
41% of red lentils (PDI: 76)
41% of fava beans (PDI: 65)
4% of green peas (PDI: 61)
41% of yellow lentils (PDI: 56)
10% of chickpeas (PDI: 56)

The process and the operating conditions for obtaining a pasta based on a mixture of legumes according to the invention are the same as those described in Example 1.

The most satisfactory results were obtained with pre-cooked flour comprising high percentages of pre-cooked flour of peeled fava beans and pre-cooked flour of dehusked red lentils (50-50%).

### EXAMPLE 4

### Pasta Based on Durum Wheat Semolina (50%) and Legumes (50%)

A pasta consisting of 50% durum wheat semolina and 50% pre-cooked flour of the mixture of legumes described in Example 3 was prepared.

The process and the operating conditions for obtaining a pasta based on legume flour and durum wheat semolina meal according to the invention are the same as those described in the Example 1.

The comparative table below shows the consistency, hydration and cooking time characteristics of a commercially available semolina pasta (“Spaghetti n°5”, Barilla), a pasta obtained according to example 4 (50% semolina, 50% legumes) and a pasta obtained according to Example 3 (50% fava beans, 50% red lentils).

| | Consistency | Hydration | Cooking time |
|---|---|---|---|
| Pasta | (J/100 g) | (%) | (minutes) |
| Spaghetti no5 (Barilla) | 6.7 | 230 | 9 |
| Spaghetti no5 (Barilla) | 6 | 240.05 | 10 |
| Spaghetti, Example 4 | 8.1 | 230.65 | 9 |
| Spaghetti, Example 4 | 7.5 | 240.65 | 10 |
| Spaghetti, Example 3 | 9.7 | 241.3 | 10 |
| Spaghetti, Example 3 | 9.3 | 246.25 | 11 |

The Table clearly shows that the pasta based on legumes (obtained according to Example 3 or Example 4 of the present invention has a consistency which is entirely comparable to, or even better than, that of the conventional durum wheat semolina pasta (“Spaghetti n°5”, Barilla).

This pasta also has a higher hydration level compared to conventional semolina pasta, while maintaining a cooking time which is entirely similar to that of semolina pasta.

### EXAMPLE 5

### Pasta Based on Pre-Cooked Flour of Red Lentils and Pre-Gelatinized Gluten-Free Cereal Flour

A pasta consisting of 50% pre-cooked flour of red lentils obtained according to Example 1 and 50% of pre-gelatinized corn flour was prepared. Mixing was carried out under the same conditions used for durum wheat semolina pasta. Dosage of the added water was equal to 40% w/w and the mixing time was 15 minutes at a temperature of 30° C.

The dough was extruded at room temperature in the form of spaghetti (diameter 1.75 mm) and was then dried with a heat cycle similar to that which is used for the production of semolina pasta with high temperature (HT) cycles of between 70° C. and 80° C.

The pasta thus obtained had a consistency entirely comparable to that of conventional durum wheat semolina pasta (“Spaghetti n°5”, Barilla), while being gluten-free.

1. A dried pasta based on a meal consisting of a pre-cooked flour of peeled legumes and optionally a gluten-containing cereal flour or semolina, wherein said pre-cooked flour of peeled legumes is in an amount of at least 50% by weight of the total weight of said meal, said dried pasta is free of binding agents and said legume flour has a protein dispersibility index (PDI) greater than or equal to 55.

2. The dried pasta according to claim 1, wherein said pre-cooked legume flour has a protein dispersibility index (PDI) greater than or equal to 60, preferably comprised between 70 and 80.

3. The dried pasta according to claim 1, wherein said pre-cooked legume flour is a flour of one or more legumes selected from the group consisting of green peas, fava beans, lentils, chickpeas and mixtures thereof and it is preferably flour of lentils and/or chickpeas.

4. The dried pasta according to claim 1, wherein said meal consists of a pre-cooked flour of dehusked lentils having a PDI of between 70 and 80, preferably equal to 76.

5. The dried pasta according to claim 1, wherein said meal consists of a pre-cooked flour of peeled chickpeas having a PDI of between 55 and 60.

6. The dried pasta according to claim 1, wherein said meal consists of a mixture of pre-cooked flours of legumes, comprising:
a pre-cooked flour of dehusked red lentils having a PDI of between 70 and 80, in an amount of between 30% and 60% by weight of the total weight of the meal;
a pre-cooked flour of peeled fava beans having a PDI of between 60 and 70, in an amount of between 30% and 60% by weight of the total weight of the meal;
a pre-cooked flour of peeled green peas having a PDI of between 60 and 70, in an amount of between 2% and 15% by weight of the total weight of the meal;
a pre-cooked flour of dehusked yellow lentils having a PDI of between 55 and 65, in an amount of between 2% and 15% by weight of the total weight of the meal;
a pre-cooked flour of peeled chickpeas having a PDI of between 55 and 65, in an amount of between 2% and 20% by weight of the total weight of the meal.

7. The dried pasta according to claim 3, wherein said meal consists of a mixture in a weight ratio 1:1 of precooked flour of dehusked red lentils having a PDI of between 70 and 80 and pre-cooked flour of peeled fava beans having a PDI of between 60 and 70.

8. The dried pasta according to claim 1, wherein said meal consists of said pre-cooked flour of peeled legumes and a gluten-containing cereal flour or semolina, and said meal comprises 50% to 80% by weight of said pre-cooked flour of peeled legumes.

9. The dried pasta according to claim 8, wherein said gluten-containing cereal flour or semolina is durum wheat semolina.

10. The dried pasta according to claim 9, wherein said pre-cooked flour of peeled legumes consists of:
a pre-cooked flour of dehusked red lentils having a PDI of between 70 and 80, in an amount of between 30% and 60% by weight of the total weight of the meal;
a pre-cooked flour of peeled fava beans having a PDI of between 60 and 70, in an amount of between 30% and 60% by weight of the total weight of the meal;
a pre-cooked flour of peeled green peas having a PDI of between 60 and 70, in an amount of between 2% and 15% by weight of the total weight of the meal;
a pre-cooked flour of dehusked yellow lentils having a PDI of between 55 and 65, in an amount of between 2% and 15% by weight of the total weight of the meal;
a pre-cooked flour of peeled chickpeas having a PDI of between 55 and 65, in an amount of between 2% and 20% by weight of the total weight of the meal.

11. The dried pasta according to claim 1, wherein said meal consists of said pre-cooked flour of peeled legumes and a pre-gelatinized flour of at least one gluten-free cereal.

12. The dried pasta according to claim 11, wherein said at least one gluten-free cereal is selected from the group consisting of corn, rice, buckwheat and quinoa.

13. A process for the production of a dried pasta according to claim 1, comprising steps of:
a) mixing, wherein said meal comprising a pre-cooked flour of peeled legumes with a protein dispersibility index (PDI) greater than or equal to 55 in an amount of at least 50% by weight of its total weight is mixed with a quantity of water equal to 35-40% of the weight of said meal to obtain a dough;
b) kneading;
c) extruding, and
d) drying, in order to bring the moisture content of the dry pasta to a value lower than or equal to 12.5%.

14. The process according to claim 13, wherein said mixing step a) occurs at a temperature of between 20° C. and 50° C. for 20-30 minutes.

15. (canceled)
